(19) United States
(12) Patent Application Publication
(10) Pub. No.: US 2026/0221412 A1
(43) Pub. Date: Jul. 30, 2026

(54) PRELITHIATION ROLLER AND PROCESS USING SAME

(71) Applicant: NISSAN NORTH AMERICA, INC., Franklin, TN (US)

(72) Inventors: Sandeep PATIL, Farmington Hills, MI (US); Santhanam RAMAN, Farmington Hills, MI (US)

(21) Appl. No.: 19/039,742

(22) Filed: Jan. 28, 2025

(51) Int. Cl. H01M 4/04; B05C 5/02

(52) U.S. Cl. CPC H01M 4/0409; B05C 5/027; H01M 4/0404

(57) ABSTRACT

A lithiation roller assembly is provided that includes a first roller. The first roller includes an outer cylinder, an inner cylinder and a plunger assembly. The outer cylinder is rotatable in a first direction and has an internal space and a plurality of openings disposed on an outer circumferential surface of the outer cylinder. The inner cylinder is stationary and housed within the internal space of the outer cylinder. The inner cylinder has a recess formed therein. The plunger assembly is arranged in the internal space between the inner and outer cylinders. The plunger assembly is fixed to the outer cylinder and in contact with the inner cylinder as the outer cylinder rotates. The plunger assembly is configured to expel content through one of the plurality of openings of the outer cylinder when the plunger assembly contacts the recess in the inner cylinder.

### BACKGROUND

### Field of the Invention

The present disclosure generally relates to a lithiation roller assembly for prelithiating the surface of an electrode, and a process for prelithiating the surface of an electrode using the prelithiation roller assembly.

### Background Information

Lithium-ion batteries that include lithium metal anodes or lithium-based cathode material are desirable because they have a high energy density and, thus, can generate a large amount of power with a relatively thin electrode structure, thus permitting a reduction in the size of the battery as compared with other conventional batteries including anodes made of carbon or silicon. Lithium-ion batteries use lithium metal anodes and/or cathodes formed of complex oxides such as lithium nickel manganese cobalt oxide (LiNiMnCoO₂, also commonly referred to as “NMC”). However, there are some drawbacks with conventional lithium-ion batteries. For example, degradation of the electrolyte during the initial charge and discharge cycles of the battery causes a solid electrolyte interphase (“SEI”) to form on the surface of the anode that faces the electrolyte. The formation of the SEI consumes a large amount of lithium ions and results in a low initial Coulombic efficiency (“ICE”) and severe decay in the energy density of the battery. For example, in the SEI formation reactions, approximately 5-15% of the capacity of the battery is consumed when a conventional graphite anode is used. In high-energy-density silicon-based anodes, the lithium loss could more severely impair the energy density due to the increase in the superficial area of the formed SEI in nanostructured silicon anodes.

### SUMMARY

In order to improve the performance and energy density of lithium-ion batteries, prelithiation of the anode, in which the anode is provided with excess lithium prior to charge and discharge, has been proposed. However, it has been determined that conventional prelithiation methods are limited by their complexity, low feasibility or lack of universality.

Therefore, further improvement is needed to develop an industrially acceptable prelithiation method or technique to deposit excess lithium on the anode before charging and discharging. In particular, it is desirable to provide a cost-effective, easily controllable and industry-adaptable method for anode prelithiation in a lithium-ion battery.

It has been discovered that the loss of lithium ions due to the formation of the SEI can be compensated by prelithiating the anode in the battery using a prelithiation roller assembly. The prelithiation assembly includes at least one roller that sprays lithium onto the electrode as the electrode material is being pressed by the roller. By providing a single roller that both sprays the lithium onto the electrode and presses the electrode, the need for a separate sprayer and roller is eliminated. In addition, prelithiation using such a roller is highly feasible due to the strong bonding force between the anode layer and the lithium deposited by the roller. As such, lithium can be successfully deposited on the electrode rolls in a continuous production process that matches well with conventional roll-to-roll battery manufacturing processes.

Therefore, it is desirable to provide a prelithiation assembly such a roller in which lithium is sprayed onto the electrode as the electrode material is being pressed by the roller.

In view of the state of the known technology, one aspect of the present disclosure is to provide a lithiation roller assembly that includes a first roller. The first roller includes an outer cylinder, an inner cylinder and a plunger assembly. The outer cylinder is rotatable in a first direction and has an internal space and a plurality of openings disposed on an outer circumferential surface of the outer cylinder. The inner cylinder is stationary and housed within the internal space of the outer cylinder. The inner cylinder has a recess formed therein. The plunger assembly is arranged in the internal space between the inner and outer cylinders. The plunger assembly is fixed to the outer cylinder and in contact with the inner cylinder as the outer cylinder rotates. The plunger assembly is configured to expel content through one of the plurality of openings of the outer cylinder when the plunger assembly contacts the recess in the inner cylinder. By using such a prelithiation roller assembly to deposit lithium on an anode, lithium in the battery during charging and discharging can be reduced as compared with conventional solid-state batteries.

Another aspect of the present disclosure is to provide a lithiation roller. The lithiation roller includes an outer cylinder that is rotatable in a first direction, an inner cylinder that is stationary and housed within the outer cylinder, and at least one plunger arranged between the inner and outer cylinders. The outer cylinder has a plurality of openings disposed on an outer circumferential surface of the outer cylinder. The inner cylinder has a recess formed therein. The at least one plunger is fixed to the outer cylinder and is in contact with the inner cylinder as the outer cylinder rotates. The at least one plunger is configured to expel a composition containing lithium through one of the plurality of openings of the outer cylinder when the at least one plunger contacts the recess in the inner cylinder.

A further aspect of the present disclosure is to provide a method of depositing lithium on an electrode. The method includes providing a first roller, supplying a composition containing the lithium to the first roller, and rotating the first roller to deposit the composition on the electrode. The first roller includes an outer cylinder that is rotatable in a first direction, an inner cylinder that is stationary and housed within the outer cylinder, and a plunger assembly arranged between the inner and outer cylinders. The outer cylinder has a plurality of openings disposed on an outer circumferential surface of the outer cylinder. The first roller is rotated to deposit the composition on the electrode through the plurality of openings. The plunger assembly is fixed to the outer cylinder and being in contact with the inner cylinder as the outer cylinder rotates.

By providing the lithiation roller that sprays the lithium composition onto an electrode while it is rotating, the process of prelithiating the electrode can be simplified while also ensuring sufficient and reliable deposition of the lithium onto the electrode before charging and discharging. In particular, by using the lithiation roller to spray the lithium composition onto the electrode, a strong bonding force is generated between the electrode and the lithium deposited by the roller. As such, lithium can be successfully deposited on the electrode rolls in a continuous production process that matches well with conventional roll-to-roll battery manufacturing processes.

### BRIEF DESCRIPTION OF THE DRAWINGS

Referring now to the attached drawings which form a part of this original disclosure:

FIG. 1 is an illustrated flow chart showing a method of producing a lithium-ion battery using a lithiation roller assembly according to a first embodiment;

FIG. 2 is a perspective view of a lithiation roller assembly according to a second embodiment;

FIG. 3 is a cross-sectional view of a lithiation roller assembly according to a third embodiment;

FIG. 4(a) is a partial cross-sectional view of a lithiation roller assembly at a first time according to a fourth embodiment;

FIG. 4(b) is a partial cross-sectional view of the lithiation roller assembly at a second time according to the fourth embodiment;

FIG. 5 is a partial perspective view of a lithiation roller assembly according to a fifth embodiment; and

FIG. 6 is a cross-sectional view of a lithium-ion battery cell stack according to a sixth embodiment.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

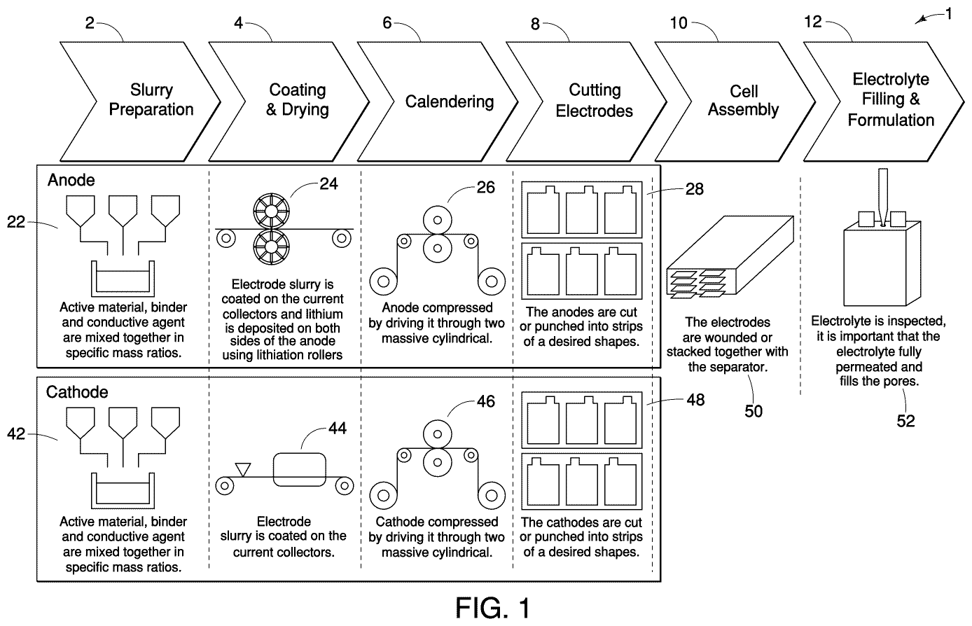

Referring initially to FIG. 1, a method 1 of forming a lithium-ion battery is illustrated according to a first embodiment. The method 1 includes the general steps of slurry preparation 2, coating and drying 4, calendering 6, cutting electrodes 8, cell assembly 10 and electrolyte filling and formulation 12. The specific steps for preparation of the anode, cathode and cell will be described below.

In Step 22, an anode slurry is prepared by mixing together an anode active material, a binder and a conductive agent to form an anode slurry. The anode active material can be any suitable anode active material for a lithium-ion battery. For example, the anode active material can be formed of graphite or nanocarbon, silicon, or a metal such as lithium.

The binder can be any suitable electrode binder material. For example, the binder can include polytetrafluoroethylene (“PTFE”), polyvinylidene fluoride (“PVDF”), styrene-butadiene rubber (“SBR”), a cellulose material or any combination thereof. The binder is preferably PTFE. The conductive agent is any suitable electrically conductive additive. For example, the conductive agent can be a carbon material, preferably a carbon black material or a carbon nanofiber having a surface area of approximately 5 m²/g to 100 m²/g.

The anode active material, binder and conductive agent can be mixed together in any suitable mass ratios. For example, the anode slurry contains approximately 90 to 95 percent by weight of the anode active material and five to ten percent by weight of the binder plus the conductive agent. For example, the anode slurry can include approximately three percent by weight of the binder and approximately two percent by weight of the conductive agent. The weight percentage values described above are relative to a total weight of the anode slurry.

In Step 24, the anode slurry is coated on each side of an anode current collector, and lithium is deposited on both of the anode slurries using lithiation rollers as shown in FIG. 1. The anode current collector is formed of any suitable metal, such as aluminum or copper, preferably copper. The anode current collector has a thickness ranging from 5 μm to 25 μm, preferably 10 μm to 12 μm.

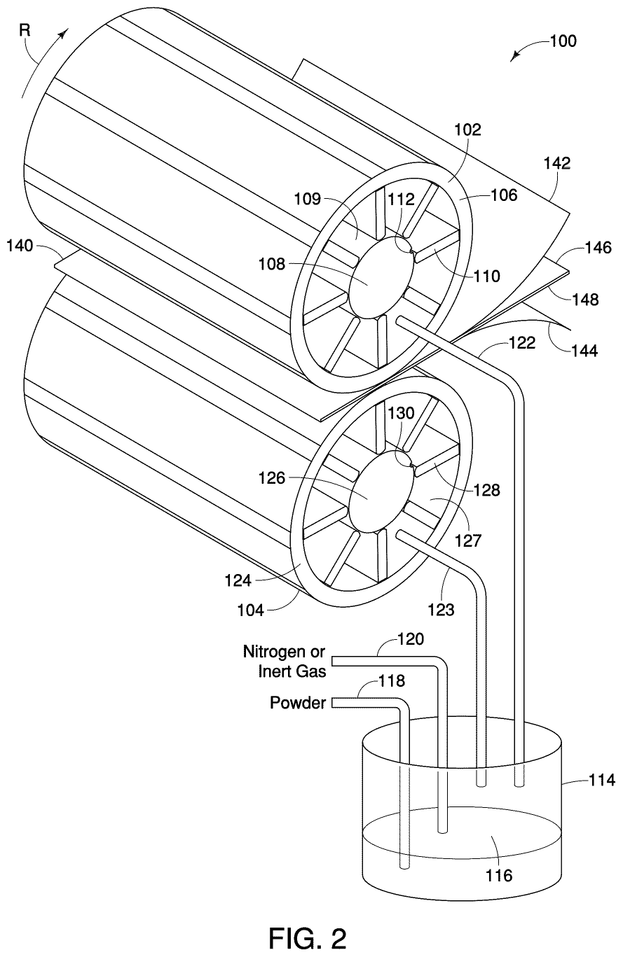

The anode slurry can be coated on the anode current collector in any suitable manner. For example, the anode slurry can be coated on each side of the anode current collector by a tape casting method. The anode slurry is then dried and sintered to form an anode layer on each side of the anode current collector. Each anode layer has a total thickness of approximately 100 μm to 300 μm. After the anode layers are formed, a composition containing lithium is sprayed or otherwise deposited in a controlled manner on both of the anode layers using the lithiation rollers to form the anode. For example, the composition containing lithium is expelled from the lithiation rollers as the rollers rotate to form lithium-containing layers each having a thickness of approximately 5 μm to 10 μm. In addition, the lithiation rollers smooth out the distribution of the lithium composition on the anode layers such that a separate roller is not needed. The details of the operation of the lithiation rollers will be described below with respect to FIGS. 2-5.

In Step 26, the anode layers having the composition containing lithium deposited thereon are compressed between two very large heated rollers in an anode calendering process. As a result, the anode layers are compressed and smoothed. The anode calendaring process can be performed in any suitable manner known to those skilled in the art.

In Step 28, the anodes formed by Steps 22, 24 and 26 are cut or punched into desired shapes. For example, the anodes can be cut or punched into any shape suitable for use in a lithium-ion battery, such as a cylindrical battery or a prismatic battery.

In Step 42, a cathode slurry is prepared by mixing together a cathode active material, a binder and a conductive agent to form a cathode slurry. The cathode active material can be any suitable cathode active material for a lithium-ion battery, such as a lithium transition metal oxide. For example, the lithium transition metal oxide material can be lithium nickel manganese cobalt oxide (LiNiMnCoO₂, “NMC”), lithium nickel cobalt aluminum oxide having the formula LiNiₓCo_{y}Al_{z}O₂, where x+y+z=1 (“NCA”), lithium cobalt oxide (LiCoO₂), lithium nickel oxide (LiNiO₂), lithium manganese oxide (LiMn₂O₄), lithium nickel manganese oxide (LiNi_{0.5}Mn_{1.5}O₄), lithium phosphate, or LiFePO₄ (“LFP”). The lithium transition metal oxide material is preferably NMC.

The binder can be any suitable electrode binder material. For example, the binder can include PTFE, PVDF, SBR, a cellulose material or any combination thereof. The binder is preferably PTFE. The conductive agent is any suitable electrically conductive additive. For example, the conductive agent can be a carbon material, preferably a carbon black material or a carbon nanofiber having a surface area of approximately 5 m²/g to 100 m²/g.

The cathode active material, binder and conductive agent can be mixed together in any suitable mass ratios. For example, the cathode slurry can contain at least 80 percent by weight of the cathode active material, preferably at least 90 percent by weight of the cathode active material. The cathode slurry can contain up to five percent by weight of the binder plus the conductive agent. For example, the cathode slurry can include approximately three percent by weight of the binder and approximately two percent by weight of the conductive agent. The weight percentage values described above are relative to a total weight of the cathode slurry.

In Step 44, the cathode slurry is coated on each side of a cathode current collector, and lithium is deposited on both of the cathode slurries using lithiation rollers as shown in FIG. 1. The cathode current collector is formed of any suitable metal, such as aluminum or copper, preferably aluminum. The cathode current collector has a thickness ranging from 5 μm to 25 μm, preferably 10 μm to 12 μm.

The cathode slurry can be coated on the cathode current collector in any suitable manner. For example, the cathode slurry can be coated on each side of the cathode current collector by a tape casting method. The cathode slurry is then dried and sintered to form a cathode layer on each side of the cathode current collector. After the cathode layers are formed, a composition containing lithium is sprayed or otherwise deposited in a controlled manner on both of the cathode layers using the lithiation rollers to form the cathode. For example, the composition containing lithium is expelled from the lithiation rollers as the rollers rotate to form lithium-containing layers each having a thickness of approximately 5 μm to 10 μm. In addition, the lithiation rollers smooth out the distribution of the lithium composition on the cathode layers such that a separate roller is not needed. The details of the operation of the lithiation rollers will be described below with respect to FIGS. 2-5. The cathode has a total thickness of approximately 70 μm to 160 μm.

In Step 46, the cathode layers having the composition containing lithium deposited thereon are compressed between two very large heated rollers in a cathode calendering process. As a result, the cathode layers are compressed and smoothed. The cathode calendaring process can be performed in any suitable manner.

In Step 48, the cathodes formed by Steps 42, 44 and 46 are cut or punched into desired shapes. For example, the cathodes can be cut or punched into any shape suitable for use in a lithium-ion battery, such as a cylindrical battery or a prismatic battery.

In Step 50, the anodes in Step 28 and the cathodes in Step 48 are wound or stacked together with a separator to assemble a lithium-ion battery cell. The separator is formed of any suitable material configured to hold a liquid electrolyte. For example, the separator is formed of a polymer, preferably polyethylene and/or polypropylene. The separator has a thickness of approximately 5 μm to 30 μm. The anodes, cathodes and separator can be stacked or wound in any suitable manner depending on the type of lithium-ion battery cell formed.

In Step 52, the lithium-ion battery cell formed in Step 50 is filled with a suitable electrolyte such that the electrolyte is fully permeated and fills the pores to form a lithium-ion battery. The electrolyte can be any suitable nonaqueous liquid electrolyte for a lithium-ion battery. For example, the electrolyte includes at least one lithium salt, such as lithium hexafluorophosphate (LiPF₆) and/or lithium bis(trifluoromethanesulfonyl)imide (“Li-TFSI”), and at least one solvent. The at least one solvent includes ethylene carbonate (“EC”), diethylene carbonate (“DEC”), dimethyl carbonate (“DMC”), ethylmethyl carbonate (“EMC”), or mixtures thereof. The electrolyte can optionally include at least one additive such as vinylene carbonate (“VC”), fluoroethylene carbonate (“FEC), and propane sultone (“PS”).

The resulting lithium-ion battery formed can be any suitable lithium-ion battery, such as a cylindrical battery or a prismatic battery. The lithium-ion battery can be incorporated in a vehicle, a mobile device, a laptop computer or other suitable personal electronic devices.

FIG. 2 shows a lithiation roller assembly 100 in accordance with a second embodiment. The lithiation roller assembly 100 can be used to deposit or spray a lithium composition in a controlled manner onto an electrode used in a lithium-ion battery.

As shown in FIG. 2, the lithiation roller assembly 100 includes a first roller 102 and a second roller 104. The first roller 102 includes an outer cylinder 106, an inner cylinder 108, a plunger assembly 110 and a recess 112 formed in the inner cylinder 108. The outer cylinder 106 is configured to rotate in a radial direction R as shown in FIG. 2 at any suitable speed, such as 0.1 rpm to 100 rpm, preferably 2-5 rpm. The outer cylinder 106 is formed of any suitable material, such as metal, that will not react with lithium. The outer cylinder 106 is preferably formed of stainless steel. For example, the outer cylinder 106 can be formed of a first metal such as stainless steel and can include heating plates formed of a second metal such as copper. The heating plates can be distributed around a circumference of the outer cylinder 106. The outer cylinder 106 has a diameter ranging from approximately 100 mm to 5,000 mm, preferably 200 mm to 2,000 mm.

Unlike the outer cylinder 106, which is configured to rotate in the radial direction R, the inner cylinder 108 is fixed and is not configured to rotate at all. The inner cylinder 108 is disposed inside the outer cylinder 106 and has a diameter of approximately 10 mm to 2,000 mm, preferably 100 mm to 500 mm. The inner cylinder 108 can be formed of any suitable material. For example, the inner cylinder 108 can be formed of a metal material such as stainless steel.

Between the outer cylinder 106 and the inner cylinder 108, in the inner space 109 of the outer cylinder 106, a plurality of plungers 110 are provided. The plungers 110 form a plunger assembly in the inner space 109 of the outer cylinder 106. The plungers 110 are fixed to the outer cylinder 106 such that the plungers 110 rotate in the radial direction R along with the outer cylinder 106. As shown in FIG. 2, each plunger 110 is also in contact with the inner cylinder 108 at a lower end of the plunger 110.

The inner cylinder 108 includes a recess 112 formed therein. The recess 112 can have any suitable width and depth, depending on the desired amount of lithium composition to be expelled or sprayed from the first roller 102 or the desired spray range for the lithium composition. The plungers 110 are configured to rotate with the outer cylinder 106 in the radial direction, and when a lower end of a given plunger 110 reaches the recess 112 in the inner cylinder 108, that plunger 110 is configured to move down into the recess 112 so that the lithium composition can be expelled from the first roller 102.

As shown in FIG. 2, the lithiation roller assembly 100 also includes a reservoir 114. The reservoir 114 holds the lithium composition 116. The lithium composition 116 can be any suitable composition that contains lithium that can be sprayed or expelled from the first roller 102. For example, the lithium composition 116 can include a mixture of lithium powder and a gas. The lithium composition 116 is not specifically limited regarding the amount of lithium powder relative to the gas, but the lithium composition 116 must include nitrogen or an inert gas to avoid any reaction between lithium and carrier gas. The lithium powder is a surface stabilized lithium powder coated with lithium carbonate and the powder is non-pyrophoric in dry environments. The lithiation roller assembly 100 includes a first line 118 configured to supply a powder containing lithium to the reservoir 114, and a second line 120 configured to supply nitrogen or an inert gas to the reservoir 114.

The reservoir 114 is configured to supply the lithium composition 116 to the first roller 102 via third line 122. The reservoir is also configured to supply the lithium composition 116 to the second roller 104 via fourth line 123. The first line 118, second line 120, third line 122 and fourth line 123 can be formed of any suitable materials, such as a metal or a plastic, preferably a flexible stainless steel material. In FIG. 2, the third line 122 is configured to supply the lithium composition 116 to the inner space 109 of the first roller 102, and the fourth line 123 is configured to supply the lithium composition 116 to the inner space 127 of the second roll 104. However, it should be understood that the third line 122 and the fourth line 123 can be configured to supply the lithium composition 116 to the first roller 102 and the second roller 104, respectively, in any suitable location, such as the inner fixed cylinder 108 and 126.

The second roller 104 includes an outer cylinder 124, an inner cylinder 126, a plunger assembly 128 and a recess 130 formed in the inner cylinder 126. The outer cylinder 124 is configured to rotate in a radial direction R as shown in FIG. 2 at any suitable speed, such as 0.1 rpm to 100 rpm, preferably 2-5 rpm. The outer cylinder 124 is formed of any suitable material, such as metal, that will not react with lithium. The outer cylinder 124 is preferably formed of stainless steel. For example, the outer cylinder 124 can be formed of a first metal such as stainless steel and can include heating plates formed of a second metal such as copper. The heating plates can be distributed around a circumference of the outer cylinder 124. The outer cylinder 124 has a diameter ranging from approximately 100 mm to 5,000 mm, preferably 200 mm to 2,000 mm.

Unlike the outer cylinder 124, which is configured to rotate in the radial direction R, the inner cylinder 126 is fixed and is not configured to rotate at all. The inner cylinder 126 is disposed inside the outer cylinder 124 and has a diameter of approximately 10 mm to 2,000 mm, preferably 100 mm to 500 mm. The inner cylinder 126 can be formed of any suitable material. For example, the inner cylinder 126 can be formed of a metal material such as stainless steel.

Between the outer cylinder 124 and the inner cylinder 126, in the inner space 127 of the outer cylinder 124, a plurality of plungers 128 are provided. The plungers 128 form a plunger assembly in the inner space 127 of the outer cylinder 124. The plungers 128 are fixed to the outer cylinder 124 such that the plungers 128 rotate in the radial direction R along with the outer cylinder 128. Each plunger 128 is also in contact with the inner cylinder 126 at a lower end of the plunger 128.

The inner cylinder 126 includes a recess 130 formed therein. The recess 130 can have any suitable width and depth, depending on the desired amount of lithium composition to be expelled or sprayed from the second roller 104. The plungers 128 are configured to rotate with the outer cylinder 124 in the radial direction, and when a lower end of a given plunger 128 reaches the recess 130 in the inner cylinder 126, that plunger 128 is configured to move down into the recess 130 and expel the lithium composition from the second roller 104.

The first roller 102 and the second roller 104 are configured to deposit the lithium composition 116 on an electrode 140. The electrode 140 can be any suitable electrode a lithium-ion battery, and the electrode 140 is preferably an anode. The electrode 140 includes a first electrode active material layer 142 and a second electrode active material layer 144.

The first and second electrode active material layers 142, 144 are each formed of a suitable active material layer for an electrode. For example, if the electrode 140 is an anode, the first and second electrode active material layers 142, 144 each contain an anode active material, a binder and a conductive agent. The anode active material can be any suitable anode active material for a lithium-ion battery. For example, the anode active material can be formed of graphite or nanocarbon, silicon, or a metal such as lithium.

The binder can be any suitable electrode binder material, such as PTFE, PVDF, SBR, a cellulose material or any combination thereof. The binder is preferably PTFE. The conductive agent is any suitable electrically conductive additive, such as a carbon material. The conductive agent is preferably a carbon black material or a carbon nanofiber having a surface area of approximately 5 m²/g to 100 m²/g.

The anode active material, binder and conductive agent can be contained in the first and second electrode active material layers 142, 144 in any suitable mass ratios. For example, the first and second electrode active material layers 142, 144 each contain approximately 90 to 95 percent by weight of the anode active material and five to ten percent by weight of the binder plus the conductive agent. The weight percentage values described above are relative to a total weight of the electrode active material layer 142 or 144.

The first electrode active material layer 142 is disposed on a first current collector 146, and the second electrode active material layer 144 is disposed on a second current collector 148. The first and second current collectors 146, 148 are formed of any suitable metal, such as aluminum or copper, preferably copper. The first and second current collectors each have a thickness ranging from 5 μm to 25 μm, preferably 10 μm to 12 μm.

The first roller 102 and the second roller 104 are configured to deposit the lithium composition 116 on the first electrode active material layer 142 and the second electrode active material layer 144, respectively. The first and second rollers 102, 104 are also configured to roll as the lithium composition 116 is being deposited.

The electrode 140 can be used in any suitable lithium-ion battery, such as a cylindrical battery or a prismatic battery. The lithium-ion battery can be incorporated in a vehicle, a mobile device, a laptop computer or other suitable personal electronic devices. By depositing excess lithium on the electrode 140 via lithium composition 116, the performance and energy density of a battery including the electrode 140 can be improved by compensating for the loss of lithium ions during charge and discharge of the battery.

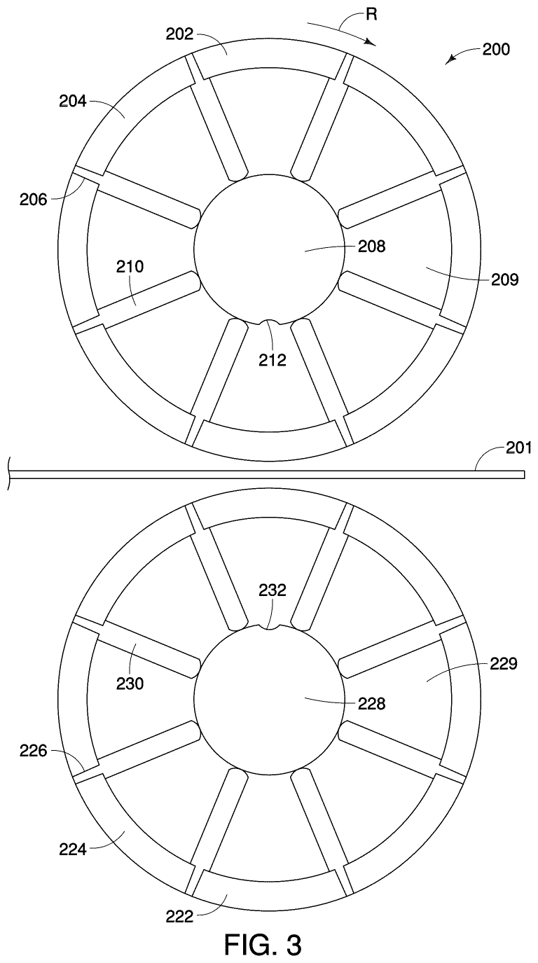

FIG. 3 shows a lithiation roller assembly 200 in accordance with a third embodiment. As with the lithiation roller assembly 100 of the second embodiment, the lithiation roller assembly 200 can be used to deposit or spray a lithium composition in a controlled manner onto an electrode used in a lithium-ion battery.

The lithiation roller assembly 200 includes a first roller 202. The first roller 202 includes an outer cylinder 204 having a plurality of openings 206, an inner cylinder 208, a plunger assembly 210 and a recess 212 formed in the inner cylinder 208. As shown in FIG. 3, the outer cylinder 204 is configured to rotate in a radial direction R at any suitable speed, such as 0.1 rpm to 100 rpm, preferably 2-5 rpm. The outer cylinder 204 is formed of any suitable material, such as metal, that will not react with lithium. The outer cylinder 204 is preferably formed of stainless steel. For example, the outer cylinder 204 can be formed of a first metal such as stainless steel and can include heating plates formed of a second metal such as copper. The heating plates can be distributed around a circumference of the outer cylinder 204. The outer cylinder 204 has a diameter ranging from approximately 100 mm to 5,000 mm, preferably 200 mm to 2,000 mm.

The outer cylinder 204 includes a plurality of openings 206. The openings 206 are formed as holes in the circumference of the outer cylinder 204. The openings 206 can have any suitable size or diameter, depending on the lithium-ion battery for which the assembly 200 is being used. As shown in FIG. 3, the openings 206 each have a smaller size at the radially outermost edge of the outer cylinder 204 than at the radially innermost edge of the outer cylinder 204. As such, the openings 206 have a tapered shape that becomes larger toward the radially innermost portion of the outer cylinder 204.

Unlike the outer cylinder 204, which is configured to rotate in the radial direction R, the inner cylinder 208 is fixed and is not configured to rotate at all. The inner cylinder 208 is disposed inside the outer cylinder 204 and has a diameter of approximately 10 mm to 2,000 mm, preferably 100 mm to 500 mm. The inner cylinder 208 can be formed of any suitable material. For example, the inner cylinder 208 can be formed of a metal material such as stainless steel.

Between the outer cylinder 204 and the inner cylinder 208, in the inner space 209 of the outer cylinder 204, a plurality of plungers 210 are provided. The plungers 210 form a plunger assembly in the inner space 209 of the outer cylinder 204. The plungers 210 are fixed to the outer cylinder 204 such that the plungers 210 rotate in the radial direction R along with the outer cylinder 204. As shown in FIG. 3, each plunger 210 is also in contact with the inner cylinder 208 at a lower end of the plunger 210.

The inner cylinder 208 includes a recess 212 formed therein. The recess 212 can have any suitable width and depth, depending on the desired amount of lithium composition to be expelled or sprayed from the first roller 202. The plungers 210 are configured to rotate with the outer cylinder 204 in the radial direction, and when a lower end of a given plunger 210 reaches the recess 212 in the inner cylinder 208, that plunger 210 is configured to move down into the recess 212 and expel the lithium composition from the first roller 202.

Although not shown in FIG. 3, the lithiation roller assembly 200 can also include a reservoir that feeds a lithium composition to the first roller 202. The reservoir can be substantially similar to or the same as the reservoir 114 of the first embodiment.

The second roller 204 includes an outer cylinder 224 having a plurality of openings 226, an inner cylinder 228, a plunger assembly 230 and a recess 232 formed in the inner cylinder 228. The outer cylinder 224 is configured to rotate in the radial direction R at any suitable speed, such as 0.1 rpm to 100 rpm, preferably 2-5 rpm. The outer cylinder 224 is formed of any suitable material, such as metal, that will not react with lithium. The outer cylinder 224 is preferably formed of stainless steel. For example, the outer cylinder 224 can be formed of a first metal such as stainless steel and can include heating plates formed of a second metal such as copper. The heating plates can be distributed around a circumference of the outer cylinder 224. The outer cylinder 224 has a diameter ranging from approximately 100 mm to 5,000 mm, preferably 200 mm to 2,000 mm.

Unlike the outer cylinder 224, which is configured to rotate in the radial direction R, the inner cylinder 228 is fixed and is not configured to rotate at all. The inner cylinder 228 is disposed inside the outer cylinder 224 and has a diameter of approximately 10 mm to 2,000 mm, preferably 100 mm to 500 mm. The inner cylinder 228 can be formed of any suitable material. For example, the inner cylinder 228 can be formed of a metal material such as stainless steel.

The outer cylinder 224 includes a plurality of openings 226. The openings 226 are formed as holes in the circumference of the outer cylinder 224. The openings 226 can have any suitable size or diameter, depending on the lithium-ion battery for which the assembly 200 is being used. As shown in FIG. 3, the openings 226 each have a smaller size at the radially outermost edge of the outer cylinder 224 than at the radially innermost edge of the outer cylinder 224. As such, the openings 226 have a tapered shape that becomes larger toward the radially innermost portion of the outer cylinder 224.

Between the outer cylinder 224 and the inner cylinder 228, in the inner space 229 of the outer cylinder 224, a plurality of plungers 230 are provided. The plungers 230 form a plunger assembly in the inner space 229 of the outer cylinder 224. The plungers 230 are fixed to the outer cylinder 224 such that the plungers 230 rotate in the radial direction R along with the outer cylinder 224. As shown in FIG. 3, each plunger 230 is also in contact with the inner cylinder 228 at a lower end of the plunger 230.

The inner cylinder 228 includes a recess 232 formed therein. The recess 232 can have any suitable width and depth, depending on the desired amount of lithium composition to be expelled or sprayed from the second roller 222. The plungers 230 are configured to rotate with the outer cylinder 224 in the radial direction, and when a lower end of a given plunger 230 reaches the recess 232 in the inner cylinder 228, that plunger 230 is configured to move down into the recess 232 and expel the lithium composition from the second roller 222.

The first roller 202 and the second roller 222 are configured to deposit the lithium composition on an electrode 201. The electrode 201 can be any suitable electrode a lithium-ion battery, and the electrode 201 is preferably an anode. The electrode 201 is substantially the same or the same as the electrode 140 of the first embodiment.

The electrode 201 can be used in any suitable lithium-ion battery, such as a cylindrical battery or a prismatic battery. The lithium-ion battery can be incorporated in a vehicle, a mobile device, a laptop computer or other suitable personal electronic devices. By depositing excess lithium on the electrode 201 via the lithium composition sprayed from the rollers 202 and 222, the performance and energy density of a battery including the electrode 201 can be improved by compensating for the loss of lithium ions during charge and discharge of the battery.

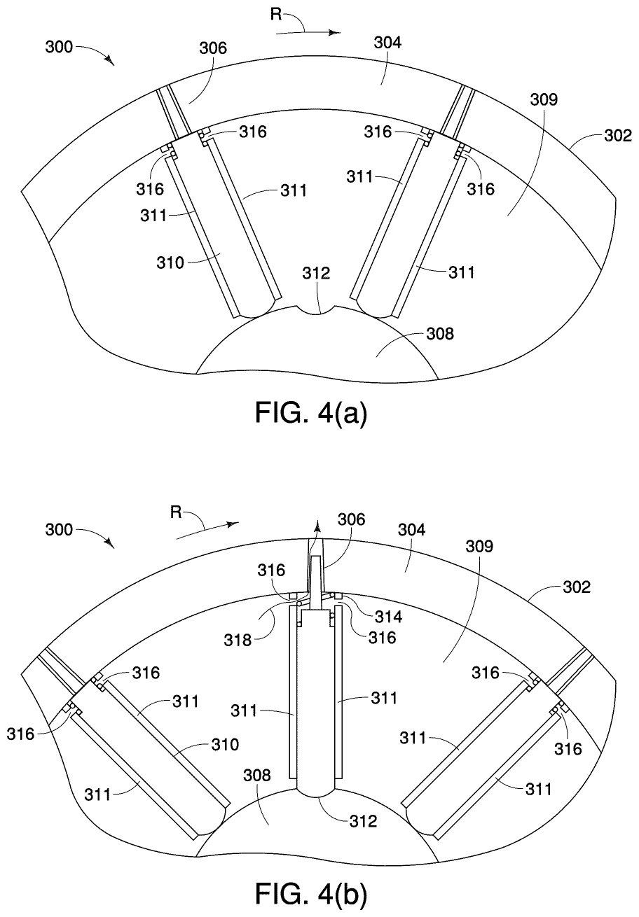

FIG. 4(a) shows a partial perspective view of a lithiation roller assembly 300 at a first time in accordance with a fourth embodiment. As with the lithiation roller assembly 100 of the second embodiment and the lithiation roller assembly 200 of the third embodiment, the lithiation roller assembly 300 can be used to deposit or spray a lithium composition in a controlled manner onto an electrode used in a lithium-ion battery that is used in a vehicle, a mobile device, a laptop computer or other suitable personal electronic devices.

The lithiation roller assembly 300 includes a roller 302. The roller 302 includes an outer cylinder 304 having a plurality of openings 306, an inner cylinder 308, a plunger assembly 310 including a plurality of tubes 311, and a recess 312 formed in the inner cylinder 208. As shown in FIG. 4(a), the outer cylinder 304 is configured to rotate in a radial direction R at any suitable speed, such as 0.1 rpm to 100 rpm, preferably 2-5 rpm. The outer cylinder 304 is formed of any suitable material, such as metal, that will not react with lithium. The outer cylinder 304 is preferably formed of stainless steel. For example, the outer cylinder 304 can be formed of a first metal such as stainless steel and can include heating plates formed of a second metal such as copper. The heating plates can be distributed around a circumference of the outer cylinder 304. The outer cylinder 304 has a diameter ranging from approximately 100 mm to 5,000 mm, preferably 200 mm to 2,000 mm.

The outer cylinder 304 includes a plurality of openings 306. The openings 306 are formed as holes in the circumference of the outer cylinder 304. As can be understood, the openings 306 are passages that extend from the inner surface of the outer cylinder 304 to the outer surface of the outer cylinder. The openings are configured to enable content to be expelled from the interior of the outer cylinder 304 to the exterior of the outer cylinder 304. The openings 306 can have any suitable size or diameter, depending on the lithium-ion battery for which the assembly 300 is being used. As shown in FIG. 4(a), the openings 306 each have a smaller size at the radially outermost edge of the outer cylinder 304 than at the radially innermost edge of the outer cylinder 304. As such, the openings 306 have a tapered shape that becomes larger toward the radially innermost portion of the outer cylinder 304.

Unlike the outer cylinder 304, which is configured to rotate in the radial direction R, the inner cylinder 308 is fixed and is not configured to rotate at all. The inner cylinder 308 is disposed inside the outer cylinder 306 and has a diameter of approximately 10 mm to 2,000 mm, preferably 100 mm to 500 mm. The inner cylinder 308 can be formed of any suitable material. For example, the inner cylinder 308 can be formed of a metal material such as stainless steel.

Between the outer cylinder 304 and the inner cylinder 308, in the inner space 309 of the outer cylinder 304, a plurality of plungers 310 held by tubes 311 are provided. As shown in FIG. 4(a) and 4(b), the tubes 311 are also provided with holes 314 and springs 316 that push the plungers 310 toward the inner cylinder 308 when the plungers 310 contact the recess 312. In particular, when the plungers 310 contact the recess 312, the springs 316 push the plungers 310 toward the inner cylinder such that lithium composition can be expelled as shown by arrow 318 through the holes 314 and the openings 306. The plungers 310, the tubes 311 with holes 314 formed therein, and the springs 316 form a plunger assembly in the inner space 309 of the outer cylinder 304. The tubes 311 can be formed of any suitable material, such as glass or plastic. The tubes 311 can be fixedly attached to the outer cylinder 304 in any suitable manner. For example, the tubes 311 can be fixed to the outer cylinder 304 by welding or bolting the tubes 311 at the center of a circular plate (not shown) which will be connected with the outer cylinder 304 using a mechanical seal. Because the tubes 311 are fixed to the outer cylinder 304 with the plungers 310 held therein, the plungers 310 and tubes 311 both rotate in the radial direction R along with the outer cylinder 304. Each plunger 310 is also in contact with the inner cylinder 308 at a lower end of the plunger 310 as shown in FIG. 4(a).

The inner cylinder 308 includes a recess 312 formed therein. The recess 312 can have any suitable width and depth, depending on the desired amount of lithium composition to be expelled or sprayed from the roller 302. The plungers 310 and tubes 311 are configured to rotate with the outer cylinder 306 in the radial direction, and when a lower end of a given plunger 310 reaches the recess 312 in the inner cylinder 308, that plunger 310 is configured to move down into the recess 312 and expel the lithium composition from the roller 302.

In particular, when the none of the plungers 310 are in contact with the recess 312 in the inner cylinder 308 at the first time as shown in FIG. 4(a), all of the plungers 310 are in contact with or abutting the openings 306 so that the openings 306 are closed and cannot receive the lithium composition therein. Therefore, at the first time shown in FIG. 4(a), lithium deposition cannot be expelled or sprayed from the roller 302.

However, at the second time shown in FIG. 4(b), the plungers 310 have rotated in the R direction such that a bottom portion of one of the plungers 310 is in contract with the recess 312 in the inner cylinder 308. At the second time, the plunger 310 in contact with the recess 312 moves down into the recess 312 while the tube 311 around that plunger 310 remains fixed to the outer cylinder 304. As a result, at the second time, the lithium composition can flow into the space between the plunger 310 and the outer cylinder 304 and can be expelled through the corresponding opening 306.

Although not shown in FIG. 4(a) or 4(b), the lithiation roller assembly 300 can also include a reservoir that feeds a lithium composition to the roller 302. The reservoir can be substantially similar to or the same as the reservoir 114 of the first embodiment.

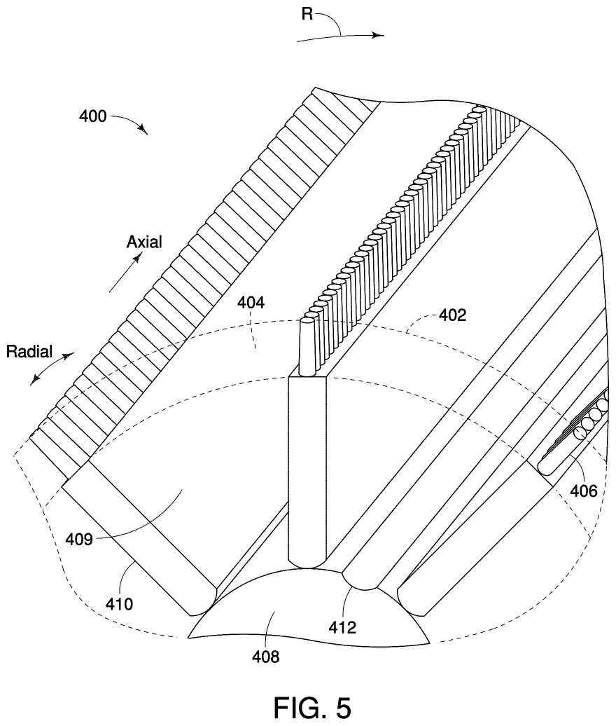

FIG. 5 shows a partial perspective view of a lithiation roller assembly 400 in accordance with a fifth embodiment. As with the lithiation roller assembly 100 of the second embodiment, the lithiation roller assembly 200 of the third embodiment, and the lithiation roller assembly 300 of the fourth embodiment, the lithiation roller assembly 400 can be used to deposit or spray a lithium composition in a controlled manner onto an electrode used in a lithium-ion battery that is used in a vehicle, a mobile device, a laptop computer or other suitable personal electronic devices.

The lithiation roller assembly 400 includes a roller 402. The roller 402 includes an outer cylinder 404 having a plurality of openings 406, an inner cylinder 408, a plunger assembly 410 and a recess 412 formed in the inner cylinder 408.

As shown in FIG. 5, the outer cylinder 404 is configured to rotate in a radial direction R at any suitable speed, such as 0.1 rpm to 100 rpm, preferably 2-5 rpm. The outer cylinder 404 is formed of any suitable material, such as metal, that will not react with lithium. The outer cylinder 404 is preferably formed of stainless steel. For example, the outer cylinder 404 can be formed of a first metal such as stainless steel and can include heating plates formed of a second metal such as copper. The heating plates can be distributed around a circumference of the outer cylinder 404. The outer cylinder 404 has a diameter ranging from approximately 100 mm to 5,000 mm, preferably 200 mm to 2,000 mm.

The outer cylinder 404 includes a plurality of openings 406. The openings 406 are formed as holes in the circumference of the outer cylinder 404. The openings 406 can have any suitable size or diameter, depending on the lithium-ion battery for which the assembly 400 is being used. As shown in FIG. 5, the openings 406 each have a smaller size at the radially outermost edge of the outer cylinder 404 than at the radially innermost edge of the outer cylinder 404. As such, the openings 406 have a tapered shape that becomes larger toward the radially innermost portion of the outer cylinder 404.

The openings 406 are arranged along the circumference of the outer cylinder 404 in both the radial direction and the axial direction as shown in FIG. 5. For example, the openings 406 are formed in rows along the axial direction, with multiple rows of the openings 406 being arranged along the circumference of the outer cylinder 404 in the radial direction. It should be understood that the plurality of openings 406 can be arranged in any suitable manner.

Unlike the outer cylinder 404, which is configured to rotate in the radial direction R, the inner cylinder 408 is fixed and is not configured to rotate at all. The inner cylinder 408 is disposed inside the outer cylinder 404 and has a diameter of approximately 10 mm to 2,000 mm, preferably 100 mm to 500 mm. The inner cylinder 408 can be formed of any suitable material. For example, the inner cylinder 408 can be formed of a metal material such as stainless steel.

Between the outer cylinder 404 and the inner cylinder 408, in the inner space 409 of the outer cylinder 404, a plurality of plungers 410 are provided. The plungers 410 form a plunger assembly in the inner space 409 of the outer cylinder 404. The plungers 410 are fixed to the outer cylinder 404 such that the plungers 410 rotate in the radial direction R along with the outer cylinder 404. As shown in FIG. 5, each plunger 410 is also in contact with the inner cylinder 408 at a lower end of the plunger 410.

The inner cylinder 408 includes a recess 412 formed therein. The recess 412 can have any suitable width and depth, depending on the desired amount of lithium composition to be expelled or sprayed from the roller 402. The plungers 410 are configured to rotate with the outer cylinder 404 in the radial direction, and when a lower end of a given plunger 410 reaches the recess 412 in the inner cylinder 408, that plunger 410 is configured to move down into the recess 412 and expel the lithium composition from the roller 402.

Although not shown in FIG. 5, the lithiation roller assembly 400 can also include a reservoir that feeds a lithium composition to the roller 402. The reservoir can be substantially similar to or the same as the reservoir 114 of the first embodiment.

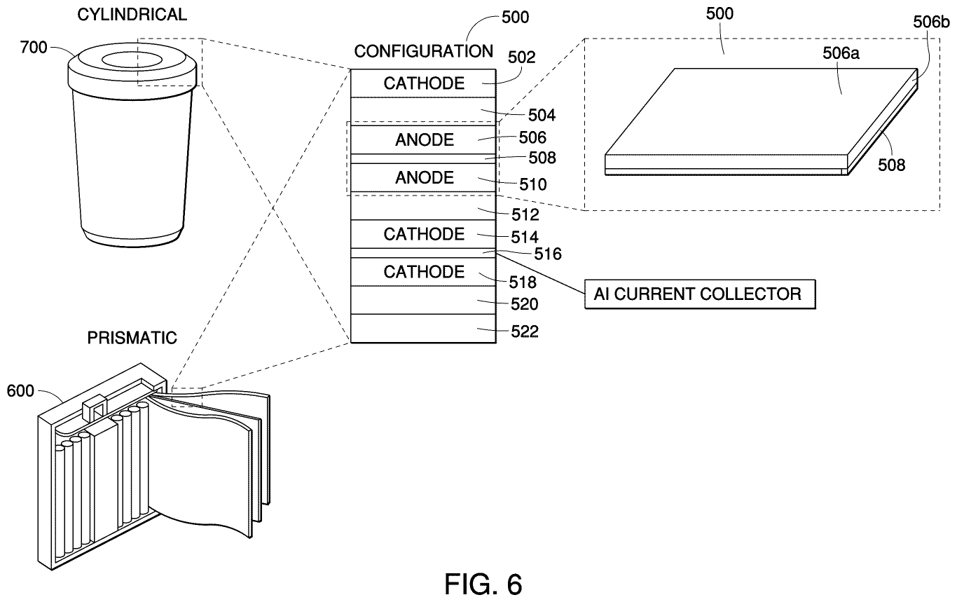

FIG. 6 shows a cross-sectional view of a lithium-ion battery cell stack 500. The battery cell stack includes a first cathode 502, a first separator 504, a first anode 506, a first anode current collector 508, a second anode 510, a second separator 512, a second cathode 514, a first cathode current collector 516, a third cathode 518, a third separator 520, and a third anode 522.

The first cathode 502 includes a cathode active material, a binder and a conductive agent. The cathode active material can be any suitable cathode active material for a lithium-ion battery, such as a lithium transition metal oxide. For example, the lithium transition metal oxide material can be NMC, NCA, lithium cobalt oxide (LiCoO₂), lithium nickel oxide (LiNiO₂), lithium manganese oxide (LiMn₂O₄), lithium nickel manganese oxide (LiNi_{0.5}Mn_{1.5}O₄), lithium phosphate, or LFP. The lithium transition metal oxide material is preferably NMC.

The binder can be any suitable electrode binder material. For example, the binder can include PTFE, PVDF, SBR, a cellulose material or any combination thereof. The binder is preferably PTFE. The conductive agent is any suitable electrically conductive additive. For example, the conductive agent can be a carbon material, preferably a carbon black material or a carbon nanofiber having a surface area of approximately 5 m²/g to 100 m²/g.

The first cathode 502 can contain at least 80 percent by weight of the cathode active material, preferably at least 90 percent by weight of the cathode active material. The first cathode 502 can contain up to five percent by weight of the binder plus the conductive agent. These weight percentage values are relative to a total weight of the first cathode 502. The first cathode 502 has a total thickness of approximately 70 μm to 160 μm.

The first separator 504 is formed of any suitable material configured to hold a liquid electrolyte. For example, the first separator 504 is formed of a polymer, preferably polyethylene and/or polypropylene. The first separator 504 has a thickness of approximately 5 μm to 30 μm.

The first anode 506 includes a first layer 506a including an anode active material, a binder, ana conductive agent. The anode active material can be any suitable anode active material for a lithium-ion battery. For example, the anode active material can be formed of graphite or nanocarbon, silicon, or a metal such as lithium.

The binder can be any suitable electrode binder material, such as PTFE, PVDF, SBR, a cellulose material or any combination thereof. The binder is preferably PTFE. The conductive agent is any suitable electrically conductive additive. For example, the conductive agent can be a carbon material, preferably a carbon black material or a carbon nanofiber having a surface area of approximately 5 m²/g to 100 m²/g.

The first layer 506a can contain approximately 90 to 95 percent by weight of the anode active material and five to ten percent by weight of the binder plus the conductive agent. These weight percentage values are relative to a total weight of the first layer 506a. The first layer 506a has a total thickness of approximately 100 μm to 300 μm.

The first anode 506 also includes a second layer 506b formed of lithium. For example, the second layer 506b can be formed of a surface stable lithium powder. The second layer 506b has a thickness of approximately 5 μm to 10 μm. The second layer 506b can be formed using a lithiation roller assembly as in the second through fifth embodiments.

The first anode current collector 508 is formed of any suitable metal, such as aluminum or copper, preferably aluminum. The first anode current collector 508 has a thickness ranging from 5 μm to 25 μm, preferably 10 μm to 12 μm.

The second anode 510 includes an anode active material, a binder, a conductive agent. The anode active material can be any suitable anode active material for a lithium-ion battery. For example, the anode active material can be formed of graphite or nanocarbon, silicon, or a metal such as lithium. The binder can be any suitable electrode binder material, such as PTFE, PVDF, SBR, a cellulose material or any combination thereof. The binder is preferably PTFE. The conductive agent is any suitable electrically conductive additive, such as a carbon material, preferably a carbon black material or a carbon nanofiber having a surface area of approximately 5 m²/g to 100 m²/g.

The second anode 510 can contain approximately 90 to 95 percent by weight of the anode active material and five to ten percent by weight of the binder plus the conductive agent. These weight percentage values are relative to a total weight of the second anode 510. The second anode 510 has a total thickness of approximately 100 μm to 300 μm.

The second separator 512 is formed of any suitable material configured to hold a liquid electrolyte. For example, the second separator 512 is formed of a polymer, preferably polyethylene and/or polypropylene. The second separator 512 has a thickness of approximately 5 μm to 30 μm.

The second cathode 514 includes a cathode active material, a binder and a conductive agent. The cathode active material can be any suitable cathode active material for a lithium-ion battery, such as NMC, NCA, lithium cobalt oxide (LiCoO₂), lithium nickel oxide (LiNiO₂), lithium manganese oxide (LiMn₂O₄), lithium nickel manganese oxide (LiNi_{0.5}Mn_{1.5}O₄), lithium phosphate, or LFP. The cathode active material is preferably NMC.

The binder can be any suitable electrode binder material, such as PTFE, PVDF, SBR, a cellulose material or any combination thereof. The binder is preferably PTFE. The conductive agent is any suitable electrically conductive additive, such as a carbon material. The conductive agent is preferably a carbon black material or a carbon nanofiber having a surface area of approximately 5 m²/g to 100 m²/g.

The second cathode 514 can contain at least 80 percent by weight of the cathode active material, preferably at least 90 percent by weight of the cathode active material. The first cathode 502 can contain up to five percent by weight of the binder plus the conductive agent. These weight percentage values are relative to a total weight of the second cathode 514. The second cathode 514 has a total thickness of approximately 70 μm to 160 μm.

The first cathode current collector 516 is formed of any suitable metal, such as aluminum or copper, preferably aluminum. The first cathode current collector 516 has a thickness ranging from 5 μm to 25 μm, preferably 10 μm to 12 μm.

The third cathode 518 includes a cathode active material, a binder and a conductive agent. The cathode active material can be any suitable cathode active material for a lithium-ion battery, such as NMC, NCA, lithium cobalt oxide (LiCoO₂), lithium nickel oxide (LiNiO₂), lithium manganese oxide (LiMn₂O₄), lithium nickel manganese oxide (LiNi_{0.5}Mn_{1.5}O₄), lithium phosphate, or LFP. The lithium transition metal oxide material is preferably NMC.

The binder can be any suitable electrode binder material, such as PTFE, PVDF, SBR, a cellulose material or any combination thereof. The binder is preferably PTFE. The conductive agent is any suitable electrically conductive additive, such as a carbon material. The conductive agent is preferably a carbon black material or a carbon nanofiber having a surface area of approximately 5 m²/g to 100 m²/g.

The third cathode 518 can contain at least 80 percent by weight of the cathode active material, preferably at least 90 percent by weight of the cathode active material. The first cathode 502 can contain up to five percent by weight of the binder plus the conductive agent. These weight percentage values are relative to a total weight of the third cathode 518. The third cathode 518 has a total thickness of approximately 70 μm to 160 μm.

The third separator 522 is formed of any suitable material configured to hold a liquid electrolyte. For example, the third separator 522 is formed of a polymer, preferably polyethylene and/or polypropylene. The third separator 522 has a thickness of approximately 5 μm to 30 μm.

The lithium-ion battery cell stack 500 can be incorporated in any suitable lithium-ion battery, such as prismatic battery 600 or cylindrical battery 700. The prismatic battery 600 and the cylindrical battery 700 can be incorporated in a vehicle, a mobile device, a laptop computer or other suitable personal electronic devices.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

1. A lithiation roller assembly comprising:
a first roller including:
an outer cylinder that is rotatable in a first direction, the outer cylinder having an internal space and a plurality of openings disposed on an outer circumferential surface of the outer cylinder;
an inner cylinder that is stationary and housed within the internal space of the outer cylinder, the inner cylinder having a recess formed therein; and
a plunger assembly arranged in the internal space between the inner and outer cylinders,
the plunger assembly being fixed to the outer cylinder and being in contact with the inner cylinder as the outer cylinder rotates, and
the first roller being configured to expel content through one of the plurality of openings of the outer cylinder when the plunger assembly contacts the recess in the inner cylinder.

2. The lithiation roller assembly according to claim 1, wherein
the first roller includes a reservoir containing the content, the content comprising lithium.

3. The lithiation roller assembly according to claim 1, wherein
the plunger assembly includes a plurality of plungers, each of the plungers extending radially between the inner and outer cylinders, and
the first roller being configured to expel the content through one of the plurality of openings of the outer cylinder when one of the plungers contacts the recess in the inner cylinder.

4. The lithiation roller assembly according to claim 3, wherein
the plunger assembly includes a plurality of tubes fixedly attached to the outer cylinder, each of the plungers being received within one of the plurality of tubes.

5. The lithiation roller assembly according to claim 4, wherein
the plurality of openings of the outer cylinder are arranged as at least one row of openings extending along a longitudinal length of the outer cylinder.

6. The lithiation roller assembly according to claim 3, wherein
each of the tubes is aligned with the plurality of openings.

7. The lithiation roller assembly according to claim 4, wherein
each of the plurality of openings have an outlet that is aligned with one of the plurality of tubes to expel the content through the plurality of openings to outside the first roller.

8. The lithiation roller assembly according to claim 3, wherein
the plurality of plungers is arranged in an array along a circumferential direction of the outer cylinder within the internal space between the inner and outer cylinders.

9. The lithiation roller assembly according to claim 2, wherein
the reservoir is defined by the internal space between the inner and outer cylinders.

10. The lithiation roller assembly according to claim 2, wherein
the reservoir is located within the inner cylinder.

11. The lithiation roller assembly according to claim 1, further comprising
a second roller including:
a second outer cylinder that is rotatable in a second direction, the second outer cylinder having a second internal space and a plurality of second openings disposed on a second outer circumferential surface of the second outer cylinder;
a second inner cylinder that is stationary and housed within the second internal space of the second outer cylinder, the second inner cylinder having a second recess formed therein; and
a second plunger assembly arranged in the second internal space between the second inner and outer cylinders,
the second plunger assembly being fixed to the second outer cylinder and being in contact with the second inner cylinder as the second outer cylinder rotates, and
the second plunger assembly being configured to expel second content through one of the plurality of second openings of the second outer cylinder when the second plunger assembly contacts the second recess in the second inner cylinder.

12. A lithiation roller comprising:
an outer cylinder that is rotatable in a first direction, the outer cylinder having a plurality of openings disposed on an outer circumferential surface of the outer cylinder;
an inner cylinder that is stationary and housed within the outer cylinder, the inner cylinder having a recess formed therein; and
at least one plunger arranged between the inner and outer cylinders,
the at least one plunger being fixed to the outer cylinder and being in contact with the inner cylinder as the outer cylinder rotates, and
the at least one plunger being configured to expel a composition containing lithium through one of the plurality of openings of the outer cylinder when the at least one plunger contacts the recess in the inner cylinder.

13. The lithiation roller according to claim 12, further comprising
a reservoir containing the composition.

14. The lithiation roller according to claim 13, wherein
the reservoir is defined by an internal space between the inner and outer cylinders.

15. The lithiation roller according to claim 13, wherein
the reservoir is located within the inner cylinder.

16. The lithiation roller according to claim 12, further comprising
at least one tube fixedly attached to the outer cylinder, each of the at least one plunger being received within one of the at least one tube.

17. The lithiation roller according to claim 16, further comprising
each of the at least one tube including a spring configured to push the plunger toward the inner cylinder.

18. The lithiation roller according to claim 12, wherein
the plurality of openings are arranged in an array along a circumferential direction of the outer cylinder.

19. A method of depositing lithium on an electrode, the method comprising:
providing a first roller comprising an outer cylinder that is rotatable in a first direction and has a plurality of openings disposed on an outer circumferential surface of the outer cylinder, an inner cylinder that is stationary and housed within the outer cylinder, and a plunger assembly arranged between the inner and outer cylinders,
supplying a composition containing the lithium to the first roller, and
rotating the first roller to deposit the composition on the electrode through the plurality of openings,
the plunger assembly being fixed to the outer cylinder and being in contact with the inner cylinder as the outer cylinder rotates.

20. The method according to claim 19, wherein
the inner cylinder has a recess formed therein, and
the plunger assembly is configured to expel the composition through one of the plurality of openings of the outer cylinder when the plunger assembly contacts the recess in the inner cylinder.
